(19) United States
(12) Patent Application Publication
(10) Pub. No.: US 2024/0167168 A1
(43) Pub. Date: May 23, 2024

(54) CARBON DIOXIDE ELECTROLYSIS APPARATUS

(71) Applicant: Honda Motor Co., Ltd., Tokyo (JP)

(72) Inventors: Daisuke Kurashina, Saitama (JP); Yuta Shimada, Saitama (JP); Teruyuki Ushijima, Saitama (JP); Phuong Tu Mai, Saitama (JP)

(21) Appl. No.: 18/385,356

(22) Filed: Oct. 30, 2023

(30) Foreign Application Priority Data
Nov. 18, 2022 (JP) 2022-185068

(51) Int. Cl. C25B 1/22; C25B 15/027; C25B 15/08

(52) U.S. Cl. CPC C25B 1/22; C25B 15/027; C25B 15/08; C25B 15/085

(57) ABSTRACT

CO₂ electrolysis apparatus includes: electrolysis stack configured to perform electrolysis using electric power generated by renewable energy; CO₂ supply unit configured to supply CO₂ to electrolysis stack; first storage unit configured to store first gas generated by electrolysis in electrolysis stack when CO₂ is supplied; second storage unit configured to store second gas generated by electrolysis in electrolysis stack when supply of CO₂ is stopped; reactor to which first and second gas stored in first and second storage unit are guided; voltage sensor configured to detect voltage of electrolysis stack; and control unit including processor and memory and configured to control CO₂ supply unit to supply CO₂ to electrolysis stack when detected voltage exceeds predetermined value and configured to control CO₂ supply unit to stop supply of CO₂ when detected voltage is equal to or less than predetermined value.

### CROSS-REFERENCE TO RELATED APPLICATION

This application is based upon and claims the benefit of priority from Japanese Patent Application No. 2022-185068 filed on Nov. 18, 2022, the content of which is incorporated herein by reference.

### BACKGROUND OF THE INVENTION

### Field of the Invention

This invention relates to a carbon dioxide electrolysis apparatus configured to electrolytically reduce carbon dioxide.

### Description of the Related Art

In the related art, an apparatus for electrolytically reducing carbon dioxide has been known (see, for example, JP 2022-131811 A). In the apparatus described in JP 2022-131811 A, an electrolytic solution including a strong alkaline aqueous solution in which carbon dioxide is dissolved is caused to flow in a liquid flow path provided between a cathode and an anode, and carbon dioxide dissolved in the electrolytic solution is electrolytically reduced at the cathode.

By recovering exhaust gas and carbon dioxide in the atmosphere and using them as a carbon source, it is possible to reduce carbon emissions and contribute to climate change mitigation or impact mitigation.

In the apparatus described in JP 2022-131811 A, when carbon dioxide is electrolyzed, hydrogen gas is generated as a by-product in addition to a desired carbon compound. By reacting the carbon compound with hydrogen obtained by such an electrolytic reaction at an appropriate ratio, a more useful compound such as a fuel can be obtained, but JP 2022-131811 A does not suggest anything about this point.

### SUMMARY OF THE INVENTION

An aspect of the present invention is a carbon dioxide electrolysis apparatus, including: an electrolysis stack configured to perform electrolysis using electric power generated by renewable energy; a carbon dioxide supply unit configured to supply carbon dioxide to the electrolysis stack; a first storage unit configured to store a first gas generated by electrolysis in the electrolysis stack when carbon dioxide is supplied by the carbon dioxide supply unit; a second storage unit configured to store a second gas generated by electrolysis in the electrolysis stack when supply of carbon dioxide by the carbon dioxide supply unit is stopped; a reactor to which the first gas stored in the first storage unit and the second gas stored in the second storage unit are guided; a voltage sensor configured to detect a voltage of the electrolysis stack; and a control unit including a processor and a memory coupled to the processor and configured to control the carbon dioxide supply unit to supply carbon dioxide to the electrolysis stack when the voltage detected by the voltage sensor exceeds a predetermined value and configured to control the carbon dioxide supply unit to stop supply of carbon dioxide to the electrolysis stack when the voltage detected by the voltage sensor is equal to or less than the predetermined value.

### BRIEF DESCRIPTION OF THE DRAWINGS

The objects, features, and advantages of the present invention will become clearer from the following description of embodiments in relation to the attached drawings, in which:

FIG. 1 is a cross-sectional view schematically illustrating an example of an electrolysis stack of a carbon dioxide electrolysis apparatus according to an embodiment of the present invention;

FIG. 2 is a block diagram schematically illustrating an example of an overall configuration of the carbon dioxide electrolysis apparatus according to the embodiment of the present invention;

FIG. 3 is a diagram for explaining fluctuations in voltage of an electrolysis stack shown in FIG. 2;

FIG. 4 is a block diagram schematically illustrating an example of a control configuration of the carbon dioxide electrolysis apparatus according to the embodiment of the present invention;

FIG. 5 is a flowchart illustrating an example of an electrolytic reaction switching process by the carbon dioxide electrolysis apparatus according to the embodiment of the present invention; and

FIG. 6 is a flowchart illustrating an example of a reactor on/off process by the carbon dioxide electrolysis apparatus according to the embodiment of the present invention.

### DETAILED DESCRIPTION OF THE INVENTION

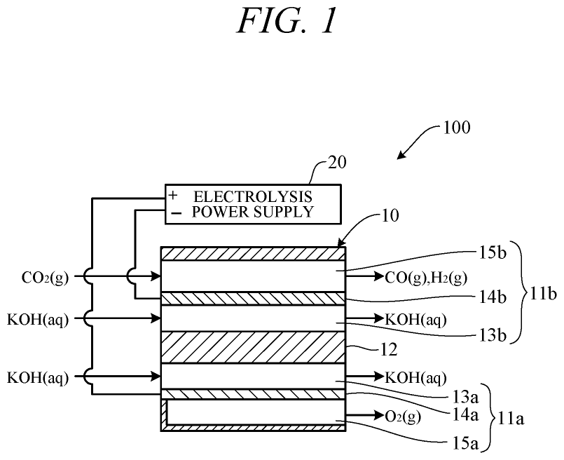

Hereinafter, an embodiment of the present invention will be described with reference to FIGS. 1 to 6. The average global temperature is maintained in a warm state suitable for organisms by greenhouse gases in the atmosphere. Specifically, some of the heat radiated from the ground surface heated by sunlight to outer space is absorbed by greenhouse gases and re-radiated to the ground surface, whereby the atmosphere is maintained in a warm state. Increasing concentrations of greenhouse gases in the atmosphere cause a rise in average global temperature (global warming).

Among the greenhouse gases, the concentration of carbon dioxide that greatly contributes to global warming in the atmosphere is determined by the balance between carbon fixed on the ground or in the ground as plants or fossil fuels and carbon present in the atmosphere as carbon dioxide. For example, carbon dioxide in the atmosphere is absorbed through photosynthesis in the growth process of plants, causing a decrease in the concentration of carbon dioxide in the atmosphere. Carbon dioxide is also released into the atmosphere through combustion of fossil fuels, causing an increase in the concentration of carbon dioxide in the atmosphere. In order to mitigate global warming, it is necessary to replace fossil fuels with renewable energy sources such as sunlight, wind power, water power, geothermal heat, or biomass to reduce carbon emissions.

Carbon dioxide in the exhaust gas or the atmosphere are recovered and used as a carbon source, whereby the carbon emission amount can be reduced. In the present embodiment, a carbon dioxide electrolysis apparatus is configured as follows so that carbon dioxide is reduced by an electrolytic reaction using renewable power to produce a carbon compound, and is further reduced using hydrogen obtained as a by-product to produce a renewable fuel or the like.

FIG. 1 is a cross-sectional view schematically illustrating an example of an electrolysis stack 10 of a carbon dioxide electrolysis apparatus (hereinafter, the apparatus) 100 according to an embodiment of the present invention. As shown in FIG. 1, the electrolysis stack 10 is configured as an electrolysis cell in which an anion exchange type solid polymer electrolyte membrane (anion exchange membrane (AEM)) 12 is sandwiched between an anode portion 11a and a cathode portion 11b or an electrolysis stack in which electrolysis cells are stacked (connected in series). The anode portion 11a and the cathode portion 11b include liquid flow paths 13a and 13b, electrocatalysts 14a and 14b, and gas flow paths 15a and 15b, respectively. The liquid flow paths 13a and 13b and the gas flow paths 15a and 15b are provided adjacent to the electrocatalysts 14a and 14b, respectively.

An electrolytic solution including a strong alkaline aqueous solution such as a potassium hydroxide aqueous solution can be introduced into the liquid flow paths 13a and 13b from the outside of the electrolysis stack 10 and circulated. The electrolytic solution flowing out from the liquid flow paths 13a and 13b may be introduced into the liquid flow paths 13a and 13b again and circulated.

Carbon dioxide can be supplied to the gas flow path 15b of the cathode portion 11b from the outside of the electrolysis stack 10. In addition, the gas generated by the electrolytic reaction can be discharged to the outside of the electrolysis stack 10 through the gas flow paths 15a and 15b.

The electrocatalyst 14a (anode) of the anode portion 11a is formed of a non-noble metal such as nickel or a noble metal such as platinum, and is connected to a positive electrode of a DC power supply (hereinafter, electrolysis power supply) 20 provided outside the electrolysis stack 10. The electrocatalyst 14b (cathode) of the cathode portion 11b is made of copper or the like, and is connected to a negative electrode of the electrolysis power supply 20.

When power is supplied from the electrolysis power supply 20 to the electrolysis stack 10, a potential difference is generated between the anode and the cathode according to the magnitude of the power, and when the potential difference reaches the electrolysis voltage, the electrolytic reaction proceeds. More specifically, when carbon dioxide is supplied to the gas flow path 15b, carbon dioxide is reduced by an electrolytic reaction at a three-phase interface among the liquid flow path 13b of the cathode portion 11b, the electrocatalyst 14b, and the gas flow path 15b to produce a carbon compound such as carbon monoxide, methane, or ethylene. For example, carbon monoxide is produced by the electrolytic reaction of the following formula (i). In addition, regardless of whether carbon dioxide is supplied to the gas flow path 15b, water in the electrolytic solution is reduced by the electrolytic reaction of the following formula (ii) to generate hydroxide ions. The carbon compound (gas) and hydrogen (gas) generated in the cathode portion 11b are discharged to the outside of the electrolysis stack 10 through the gas flow path 15b.

CO₂+H₂O→CO+2OH⁻ (i)

2H₂O→H₂+2OH⁻ (ii)

On the other hand, hydroxide ions generated in the cathode portion 11b move in the electrolytic solution in the liquid flow path 13b of the cathode portion 11b, then pass through the AEM 12, and move in the electrolytic solution in the liquid flow path 13a of the anode portion 11a to the interface with the electrocatalyst 14a of the anode portion 11a. On the surface of the electrocatalyst 14a of the anode portion 11a, hydroxide ions are oxidized by the electrolytic reaction of the following formula (iii) to generate oxygen. Oxygen (gas) generated in the anode portion 11a is discharged to the outside of the electrolysis stack 10 through the gas flow path 15a, and water (liquid) circulates through the liquid flow path 13a as it is.

4OH^{-→O}₂+2H₂O (iii)

The electrolysis voltage required for the electrolytic reaction of carbon dioxide, that is, the electrolysis voltage (about 1.35 V) required for the electrolytic reaction of the above formulae (i) and (iii), is higher than the electrolysis voltage required for the electrolytic reaction of water, that is, the electrolysis voltage (about 1.23 V) required for the electrolytic reaction of the above formulae (ii) and (iii).

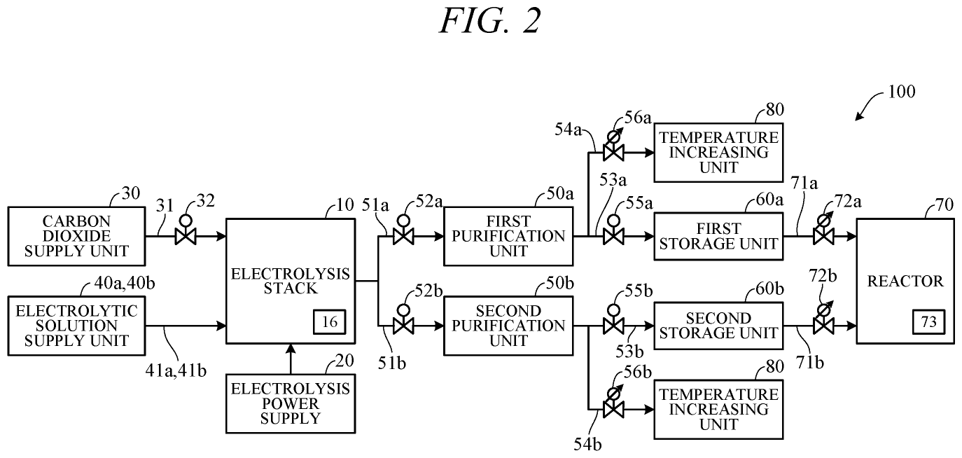

FIG. 2 is a block diagram schematically illustrating an example of an overall configuration of the apparatus 100. As shown in FIG. 2, the apparatus 100 includes an electrolysis stack 10, an electrolysis power supply 20 that supplies power to the electrolysis stack 10, a carbon dioxide supply unit 30 that supplies carbon dioxide to the electrolysis stack 10, and electrolytic solution supply units 40a and 40b that supply an electrolytic solution to the electrolysis stack 10.

The electrolysis stack 10 is provided with a voltage sensor 16 which detects the voltage (hereinafter, the stack voltage) of the electrolysis stack 10. The voltage sensor 16 is connected to the controller 90 (see FIG. 4), and the sensor value of the voltage sensor 16 is output to the controller 90.

The electrolysis power supply 20 is configured as a power generation device that generates DC power (renewable power) using renewable energy such as sunlight and supplies the generated DC power to the electrolysis stack 10. The positive electrode of the electrolysis power supply 20 is connected to the anode of the electrolysis stack 10 (the electrocatalyst 14a of the anode portion 11a), and the negative electrode of the electrolysis power supply 20 is connected to the cathode of the electrolysis stack 10 (the electrocatalyst 14b of the cathode portion 11b). The amount of power generated by the electrolysis power supply 20 using natural energy such as sunlight varies depending on weather conditions such as sunlight, whereby the stack voltage of the electrolysis stack 10 varies.

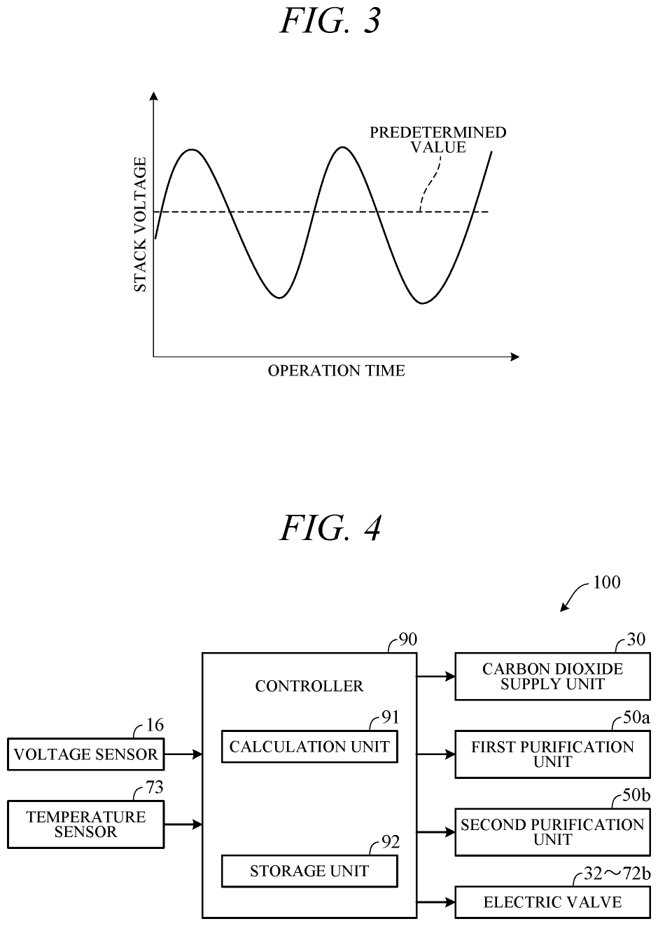

FIG. 3 is a diagram for explaining fluctuations in the stack voltage. As shown in FIG. 3, the power generation amount in the case of using natural energy such as sunlight varies depending on weather conditions such as sunlight, and the stack voltage also varies with the variation in the power generation amount. When the stack voltage is equal to or lower than the electrolysis voltage (predetermined value) required for the electrolytic reaction of carbon dioxide, even if carbon dioxide is supplied to the electrolysis stack 10, the electrolytic reaction of carbon dioxide (compounds represented by formulae (i) and (iii)) does not proceed, and only the electrolytic reaction of water (compounds represented by formulae (ii) and (iii)) proceeds.

The carbon dioxide supply unit 30 includes a pump and the like. The carbon dioxide supply unit 30 is connected to an inlet of the gas flow path 15b of the cathode portion 11b of the electrolysis stack 10 via a pipe 31, and supplies carbon dioxide (gas) to the electrolysis stack 10 by pumping air containing carbon dioxide at a predetermined concentration or more. The air containing carbon dioxide at a predetermined concentration or more may be an exhaust gas from a device or equipment that involves combustion of fossil fuel, or may be the atmosphere in which carbon dioxide is concentrated by a concentration device. An electric valve 32 configured to be openable and closable is provided in the pipe 31 between the carbon dioxide supply unit 30 and the electrolysis stack 10. The carbon dioxide supply unit 30 and the electric valve 32 are controlled by the controller 90 (see FIG. 4).

The electrolytic solution supply units 40a and 40b each include a pump and the like. The electrolytic solution supply units 40a and 40b are connected to inlets of the liquid flow paths 13a and 13b of the electrolysis stack 10 via pipes 41a and 41b, respectively, and supply the electrolytic solution to the electrolysis stack 10 by pumping the electrolytic solution. The electrolytic solution is refluxed to the electrolytic solution supply units 40a and 40b from outlets of the liquid flow paths 13a and 13b of the electrolysis stack 10 through pipes (not illustrated), respectively.

The apparatus 100 further includes a first purification unit 50a and a second purification unit 50b that purify the gas generated by electrolysis in the electrolysis stack 10, and a first storage unit 60a and a second storage unit 60b that store the gas supplied from the first purification unit 50a and the second purification unit 50b, respectively. The apparatus 100 further includes a reactor 70 to which the gas stored in the first storage unit 60a and the second storage unit 60b is guided, and a temperature increasing unit 80 that increases the temperature of the reactor 70.

When carbon dioxide is supplied by the carbon dioxide supply unit 30, the first purification unit 50a purifies a first gas containing, as a main component, the carbon compound generated by electrolysis in the electrolysis stack 10. The first purification unit 50a is configured as an adsorption separation device of a pressure swing adsorption (PSA) system or a thermal swing adsorption (TSA) system using an adsorbent.

The first purification unit 50a is connected to an outlet of the gas flow path 15b of the cathode portion 11b of the electrolysis stack 10 via a pipe 51a, and the pipe 51a is provided with an electric valve 52a configured to be openable and closable. When carbon dioxide is supplied by the carbon dioxide supply unit 30, the electric valve 52a is opened, the first gas generated by electrolysis is supplied from the electrolysis stack 10 to the first purification unit 50a, and a mixture other than the carbon compound contained in the first gas is adsorbed (pressurized adsorption in the case of the PSA method, and room temperature adsorption in the case of the TSA method) by an adsorbent. The electric valve 52a is controlled by the controller 90 (see FIG. 4).

The first purification unit 50a is further connected to the first storage unit 60a via the pipe 53a, and connected to the temperature increasing unit 80 via the pipe 54a. An electric valve 55a configured to be openable and closable is provided in the pipe 53a between the first purification unit 50a and the first storage unit 60a, and an electric valve 56a configured to be able to adjust a flow rate is provided in the pipe 54a between the first purification unit 50a and the temperature increasing unit 80.

When the mixture other than the carbon compound contained in the first gas is adsorbed by the adsorbent in the first purification unit 50a, the electric valve 55a is opened and the electric valve 56a is closed, and the purified high-purity carbon compound is supplied from the first purification unit 50a to the first storage unit 60a and stored. On the other hand, when the mixture other than the carbon compound is desorbed (decompression desorption in the case of the PSA method, and high temperature desorption in the case of the TSA method) from the adsorbent in the first purification unit 50a, the electric valve 55a is closed and the electric valve 56a is opened, and an off-gas containing the mixture desorbed from the adsorbent is supplied from the first purification unit 50a to the temperature increasing unit 80. The first purification unit 50a and the electric valves 55a and 56a are controlled by the controller 90 (see FIG. 4).

When the supply of carbon dioxide by the carbon dioxide supply unit 30 is stopped, the second purification unit 50b purifies a second gas mainly composed of hydrogen generated by electrolysis in the electrolysis stack 10. The second purification unit 50b is also configured as a PSA type or TSA type adsorption separation device using an adsorbent.

The second purification unit 50b is connected to the outlet of the gas flow path 15b of the cathode portion 11b of the electrolysis stack 10 via the pipe 51b, and the pipe 51b is provided with an electric valve 52b configured to be openable and closable. When the supply of carbon dioxide by the carbon dioxide supply unit 30 is stopped, the electric valve 52b is opened, the second gas generated by electrolysis is supplied from the electrolysis stack 10 to the second purification unit 50b, and the mixture other than hydrogen contained in the second gas is adsorbed by the adsorbent. The electric valve 52b is controlled by the controller 90 (see FIG. 4).

The second purification unit 50b is further connected to the second storage unit 60b via the pipe 53b, and connected to the temperature increasing unit 80 via a pipe 54b. An electric valve 55b configured to be openable and closable is provided in the pipe 53b between the second purification unit 50b and the second storage unit 60b, and an electric valve 56b configured to be able to adjust a flow rate is provided in the pipe 54b between the second purification unit 50b and the temperature increasing unit 80.

When the mixture other than hydrogen contained in the second gas is adsorbed by the adsorbent in the second purification unit 50b, the electric valve 55b is opened and the electric valve 56b is closed, and purified high-purity hydrogen is supplied from the second purification unit 50b to the second storage unit 60b and stored. On the other hand, when the mixture other than hydrogen is desorbed from the adsorbent in the second purification unit 50b, the electric valve 55b is closed and the electric valve 56b is opened, and the off-gas containing the mixture desorbed from the adsorbent is supplied from the second purification unit 50b to the temperature increasing unit 80. The second purification unit 50b and the electric valves 55b and 56b are controlled by the controller 90 (see FIG. 4).

The reactor 70 is connected to the first storage unit 60a via a pipe 71a, and is connected to the second storage unit 60b via a pipe 71b. Electric valves 72a and 72b configured to be able to adjust flow rates are provided in the pipe 71b and the pipe 71b, respectively. The high-purity carbon compound stored in the first storage unit 60a is introduced into the reactor 70 according to the opening degree of the electric valve 72a, and the high-purity hydrogen stored in the second storage unit 60b is introduced according to the opening degree of the electric valve 72b. The electric valves 72a and 72b are controlled by the controller 90 (see FIG. 4).

The temperature increasing unit 80 is configured as a heat exchanger provided to cover the entire reactor 70, and increases the temperature of the reactor 70 by the off-gas (heating medium) supplied from the first purification unit 50a and the second purification unit 50b. The reactor 70 is provided with a temperature sensor 73 that detects the temperature of the reactor 70. The temperature sensor 73 is connected to the controller 90 (see FIG. 4), and the sensor value of the temperature sensor 73 is output to the controller 90.

In the reactor 70, a carbon compound supplied from the first storage unit 60a is reduced by hydrogen supplied from the second storage unit 60b to produce a renewable fuel or the like. For example, renewable methanol fuel is produced by Fischer-Tropsch (FT) synthesis. The reactor 70 is configured as a catalytic reactor provided with a catalyst capable of promoting a reaction for obtaining a desired renewable fuel or the like. The temperature of the reactor 70 can be adjusted by the electric valves 56a and 56b via the flow rate of the heating medium according to the type of reaction for obtaining a desired renewable fuel or the like. The ratio and the flow rate of reactants (carbon dioxide, hydrogen) introduced into the reactor 70 can be adjusted by the electric valves 72a and 72b in consideration of the temperature, pressure, and the like in the reactor 70 according to the type of reaction for obtaining a desired renewable fuel and the like.

FIG. 4 is a block diagram schematically illustrating an example of a control configuration of the apparatus 100. As shown in FIG. 4, the apparatus 100 further includes a controller 90 that controls the carbon dioxide supply unit 30, the electrolytic solution supply units 40a and 40b, the first purification unit 50a, the second purification unit 50b, and the electric valve 32 to 72b. A voltage sensor 16 and a temperature sensor 73 are connected to the controller 90. The controller 90 includes a computer including a calculation unit 91 such as a CPU, a storage unit 92 such as a ROM and a RAM, and peripheral circuits thereof. The storage unit 92 of the controller 90 stores programs executed by the calculation unit 91 and information such as setting values.

When the stack voltage detected by the voltage sensor 16 exceeds a predetermined value (see FIG. 3), the controller 90 (the calculation unit 91) controls the carbon dioxide supply unit 30 and the electric valve 32 to supply carbon dioxide to the electrolysis stack 10. In addition, the electric valves 52a and 52b are controlled so that the first gas is supplied from the electrolysis stack 10 to the first purification unit 50a, and the first purification unit 50a is controlled so as to purify the supplied first gas. Furthermore, the electric valves 55a and 56a are controlled so that the high-purity carbon compound purified in the first purification unit 50a is supplied to the first storage unit 60a, and the off-gas containing the mixture desorbed from the adsorbent is supplied to the temperature increasing unit 80.

The controller 90 controls the carbon dioxide supply unit 30 and the electric valve 32 to stop the supply of carbon dioxide to the electrolysis stack 10 when the stack voltage detected by the voltage sensor 16 is equal to or less than a predetermined value. In addition, the electric valves 52a and 52b are controlled so that the second gas is supplied from the electrolysis stack 10 to the second purification unit 50b, and the second purification unit 50b is controlled so as to purify the supplied second gas. Further, the electric valves 55b and 56b are controlled so that the high purity hydrogen purified in the second purification unit 50b is supplied to the second storage unit 60b and the off-gas containing the mixture desorbed from the adsorbent is supplied to the temperature increasing unit 80.

The controller 90 further controls the electric valves 56a and 56b according to the temperature of the reactor 70 detected by the temperature sensor 73 so that the temperature of the reactor 70 becomes a predetermined temperature capable of promoting a reaction for obtaining a desired renewable fuel or the like. When the temperature of the reactor 70 is equal to or higher than the predetermined temperature, the electric valves 72a and 72b are controlled so that the reactant (carbon dioxide, hydrogen) is supplied from the first storage unit 60a and the second storage unit 60b to the reactor 70. When the temperature of the reactor 70 is lower than the predetermined temperature, a desired reaction does not proceed even if the reactant (carbon dioxide, hydrogen) is supplied to the reactor 70, and thus, the electric valves 72a and 72b are controlled to stop the supply of the reactant from the first storage unit 60a and the second storage unit 60b to the reactor 70.

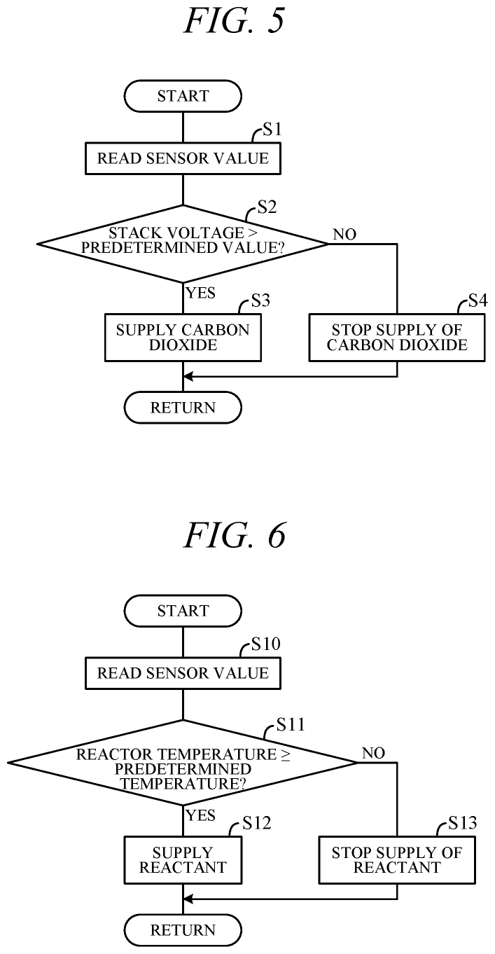

FIG. 5 is a flowchart illustrating an example of an electrolytic reaction switching process by the apparatus 100, and illustrates an example of a process executed by the calculation unit 91 of the controller 90. The processing illustrated in the flowchart is repeatedly executed at predetermined time intervals. As shown in FIG. 5, first, in step S1, the stack voltage of the electrolysis stack 10 detected by the voltage sensor 16 is read. Next, in step S2, it is determined whether or not the stack voltage read in step S1 exceeds a predetermined value (see FIG. 3).

In a case where determination is positive in step S2, the process proceeds to step S3, and the carbon dioxide supply unit 30 and the electric valve 32 are controlled to supply carbon dioxide to the electrolysis stack 10. In addition, the electric valves 52a and 52b are controlled so that the first gas is supplied from the electrolysis stack 10 to the first purification unit 50a, and the first purification unit 50a is controlled so as to purify the first gas. In addition, the electric valves 55a and 56a are controlled so that the first gas (high-purity carbon compound) purified in the first purification unit 50a is supplied to the first storage unit 60a, and the off-gas containing the mixture desorbed from the adsorbent is supplied to the temperature increasing unit 80.

On the other hand, in a case where determination is negative in step S2, the process proceeds to step S4, and the carbon dioxide supply unit 30 and the electric valve 32 are controlled to stop the supply of carbon dioxide to the electrolysis stack 10. In addition, the electric valves 52a and 52b are controlled so that the second gas is supplied from the electrolysis stack 10 to the second purification unit 50b, and the second purification unit 50b is controlled so as to purify the second gas. In addition, the electric valves 55b and 56b are controlled so that the second gas (high purity hydrogen) purified in the second purification unit 50b is supplied to the second storage unit 60b, and the off-gas containing the mixture desorbed from the adsorbent is supplied to the temperature increasing unit 80.

The power generation amount in the case of using natural energy such as sunlight varies depending on weather conditions such as sunlight, and the stack voltage also varies with the variation in the power generation amount. When the stack voltage is equal to or lower than the electrolysis voltage (predetermined value) of carbon dioxide, only water electrolysis is performed by stopping the supply of carbon dioxide to the electrolysis stack 10, and when the stack voltage exceeds the predetermined value, carbon dioxide is supplied to the electrolysis stack 10 to perform the electrolysis of carbon dioxide. As described above, a plurality of substances (carbon compound and hydrogen) can be efficiently generated by switching a plurality of electrolytic reactions having different electrolysis voltages according to the fluctuation of the renewable power.

FIG. 6 is a flowchart illustrating an example of a reactor on/off process by the apparatus 100, and illustrates an example of a process executed by the calculation unit 91 of the controller 90. The processing illustrated in the flowchart is repeatedly executed at predetermined time intervals. As shown in FIG. 6, first, in step S10, the temperature of the reactor 70 detected by the temperature sensor 73 is read. Next, in step S11, it is determined whether or not the temperature read in step S10 is a predetermined temperature or more.

In a case where determination is positive in Step S11, the process proceeds to Step S12, and the electric valves 72a and 72b are controlled so that the reactant (carbon dioxide, hydrogen) is supplied from the first storage unit 60a and the second storage unit 60b to the reactor 70. On the other hand, in a case where determination is negative in step S11, the process proceeds to step S13, and the electric valves 72a and 72b are controlled to stop the supply of the reactant from the first storage unit 60a and the second storage unit 60b to the reactor 70.

As described above, by storing the produced carbon compound and hydrogen, respectively, and then introducing the carbon compound and hydrogen into the reactor 70, the carbon compound and hydrogen obtained by the electrolytic reaction in the single electrolysis stack 10 can be reacted at an appropriate ratio. In addition, by raising the temperature of the reactor 70 using a waste heat of the off-gas generated by purification and supplying the reaction gas to the reactor 70 when the reaction temperature is secured, the efficiency of the entire apparatus 100 can be further improved.

According to the present embodiment, the following functions and effects can be achieved.

(1) The apparatus 100 includes an electrolysis stack 10 that performs electrolysis using electric power generated by renewable energy, a carbon dioxide supply unit 30 that supplies carbon dioxide to the electrolysis stack 10, a first storage unit 60a that stores a first gas generated by electrolysis in the electrolysis stack 10 when carbon dioxide is supplied by the carbon dioxide supply unit 30, a second storage unit 60b that stores a second gas generated by electrolysis in the electrolysis stack 10 when the supply of carbon dioxide by the carbon dioxide supply unit 30 is stopped, a reactor 70 to which the first gas stored in the first storage unit 60a and the second gas stored in the second storage unit 60b are guided, a voltage sensor 16 that detects a stack voltage of the electrolysis stack 10, and a controller 90 that controls the carbon dioxide supply unit 30 to supply carbon dioxide to the electrolysis stack 10 when the stack voltage detected by the voltage sensor 16 exceeds a predetermined value and controls the carbon dioxide supply unit 30 to stop the supply of carbon dioxide to the electrolysis stack 10 when the stack voltage detected by the voltage sensor 16 is equal to or less than a predetermined value (see FIGS. 2 and 4).

As described above, it is possible to efficiently produce the carbon compound and hydrogen by switching the supply and non-supply of carbon dioxide according to the fluctuation of the stack voltage accompanying the fluctuation of the renewable power. In addition, the carbon compound and hydrogen obtained by electrolysis in the single electrolysis stack 10 are stored and then introduced into the reactor 70, whereby the carbon compound and hydrogen can be reacted at an appropriate ratio.

(2) The apparatus 100 further includes a first purification unit 50a that purifies the first gas and supplies the purified first gas to the first storage unit 60a, a second purification unit 50b that purifies the second gas and supplies the purified second gas to the second storage unit 60b, and a temperature increasing unit 80 that increases the temperature of the reactor 70 by the off-gas generated in the first purification unit 50a and the second purification unit 50b (see FIG. 2). By using the waste heat of the off-gas generated by the purification, the efficiency of the entire apparatus 100 can be further improved.

(3) The apparatus 100 further includes a temperature sensor 73 that detects the temperature of the reactor 70 and electric valves 72a and 72b (see FIGS. 2 and 4). The controller 90 controls the flows of the first gas and the second gas to the reactor 70 according to the temperature of the reactor 70 detected by the temperature sensor 73. By supplying the reaction gas according to the temperature of the reactor 70, the efficiency of the entire apparatus 100 can be further improved.

In the above embodiment, the electrolytic reaction that proceeds on the cathode side of the electrolysis stack 10 when carbon dioxide is supplied has been described as an electrolytic reduction reaction from carbon dioxide to carbon monoxide in FIG. 1 and the like, but carbon monoxide is an example, and the first gas generated by electrolysis when carbon dioxide is supplied is not limited to carbon monoxide. The electrolytic reaction for purifying the first gas from carbon dioxide may be a reaction in which an electrolysis voltage is different from an electrolysis voltage of an electrolytic reaction of water, which is a side reaction.

The above embodiment can be combined as desired with one or more of the aforesaid modifications. The modifications can also be combined with one another.

According to the present invention, carbon compound and hydrogen obtained by electrolytic reaction can react at an appropriate ratio.

Above, while the present invention has been described with reference to the preferred embodiments thereof, it will be understood, by those skilled in the art, that various changes and modifications may be made thereto without departing from the scope of the appended claims.

1. A carbon dioxide electrolysis apparatus, comprising:
an electrolysis stack configured to perform electrolysis using electric power generated by renewable energy;
a carbon dioxide supply unit configured to supply carbon dioxide to the electrolysis stack;
a first storage unit configured to store a first gas generated by electrolysis in the electrolysis stack when carbon dioxide is supplied by the carbon dioxide supply unit;
a second storage unit configured to store a second gas generated by electrolysis in the electrolysis stack when supply of carbon dioxide by the carbon dioxide supply unit is stopped;
a reactor to which the first gas stored in the first storage unit and the second gas stored in the second storage unit are guided;
a voltage sensor configured to detect a voltage of the electrolysis stack; and
a control unit including a processor and a memory coupled to the processor and configured to control the carbon dioxide supply unit to supply carbon dioxide to the electrolysis stack when the voltage detected by the voltage sensor exceeds a predetermined value and configured to control the carbon dioxide supply unit to stop supply of carbon dioxide to the electrolysis stack when the voltage detected by the voltage sensor is equal to or less than the predetermined value.

2. The carbon dioxide electrolysis apparatus according to claim 1, further comprising:
a first purification unit configured to purify the first gas to supply the purified first gas to the first storage unit;
a second purification unit configured to purify the second gas to supply the purified second gas to the second storage unit; and
a temperature increasing unit configured to increase a temperature of the reactor by off-gas generated in the first purification unit and the second purification unit.

3. The carbon dioxide electrolysis apparatus according to claim 1, further comprising:
a temperature sensor configured to detect a temperature of the reactor; and
a flow control unit configured to control flows of the first gas and the second gas to the reactor based on the temperature of the reactor detected by the temperature sensor.

4. The carbon dioxide electrolysis apparatus according to claim 1, wherein
the first gas contains carbon compound, wherein
the second gas contains hydrogen, wherein
the reactor produces a renewable fuel by electrolytically reducing the carbon compound contained in the first gas using the hydrogen contained in the second gas.
